(19) United States
(12) Patent Application Publication
(10) Pub. No.: US 2026/0251898 A1
(43) Pub. Date: Aug. 27, 2026

(54) HEAD-UP DISPLAY DEVICE

(71) Applicant: HYUNDAI MOBIS CO., LTD., Seoul (KR)

(72) Inventors: Byung Ki KIM, Yongin-si (KR); Hyun Ki LEE, Yongin-si (KR)

(73) Assignee: HYUNDAI MOBIS CO., LTD., Seoul (KR)

(21) Appl. No.: 19/059,490

(22) Filed: Feb. 21, 2025

(51) Int. Cl. G02B 27/01

(52) U.S. Cl. CPC G02B 27/0101; G02B 27/0149; G02B 2027/014; G02B 2027/0163

(57) ABSTRACT

According to one embodiment of the present disclosure, there is provided a head-up display device comprising: a picture generation unit (PGU) configured to output an image; a first mirror disposed in front of the PGU along a frontward optical path and configured to change a path of the image, and configured to transmit at least a portion of a wavelength of light therethrough; a second mirror disposed in front of the first mirror, configured to pivot to between a first position and a second position; and a printed circuit board (PCB) on which at least one sensor is mounted, wherein the sensor measures an illuminance of the external incoming light incoming along a backward optical path, wherein the at least one sensor is positioned at a position around the position of the PCB corresponding to the point of the first mirror which the chief ray reaches.

### TECHNICAL FIELD

The present disclosure relates to a head-up display device.

### BACKGROUND

The contents described in this section merely provides background information on the present disclosure and does not constitute the prior art.

The head-up display is a driving information display device developed for safe driving of vehicle drivers. The driving information is formed in a form of an image in a picture generation unit (PGU), which is an image output component, and passes through an optical system and then is projected onto a windshield of the vehicle or a translucent reflection screen disposed inside the vehicle.

The external incoming light incident within a specific angle range through the vehicle front glass passes through the optical system of the HUD in the opposite direction, so that the cross-sectional area thereof is reduced and thus the light is substantially condensed. That is, the external incoming light in a state in which thermal energy per unit cross-sectional area is greatly increased is incident on the PGU. The PGU may include various components for outputting an image. The various components included in the PGU are vulnerable to heat. Thus, when the components are exposed to the external incoming light for a certain period of time or longer, they may be deformed and damaged by heat. That is, the PGU may be thermally damaged by the external incoming light.

The head-up display device capable of detecting the external incoming light using a sensor so that the PGU is not thermally damaged and activating a protection mode so that the external incoming light is not incident on the PGU using a light shielding device when the detected amount of sunlight exceeds a threshold value may be designed. However, when the protection mode is activated, there is a problem in that the sensor may no longer sense the sunlight, and thus it is difficult to determine the inactivation of the protection mode.

Further, the incident angle of the external incoming light may be identified after passing through at least one optical element, and may be more easily identified after the cross-sectional area of the incoming light is reduced after passing through a plurality of optical elements. Therefore, it is preferable that the sensor for sensing the external incoming light is disposed adjacent to the PGU. However, when the sensor senses the external incoming light in an excessively sensitive manner, the protection mode may be activated even when the sunlight is not incident on the PGU. Thus, the arrangement design of the sensor is very important.

Accordingly, there is also a method of adjusting the sensitivity at which the external incoming light is sensed by using not only a sensor for sensing the external incoming light but also a sensor for sensing a temperature in parallel with each other. However, this approach has a problem in that the structure and system of the head-up display device become too complicated, and the manufacturing cost of the head-up display device is excessively increased.

### SUMMARY

Accordingly, the present disclosure is intended to solve these problems, and the main purpose of the present disclosure is to provide a head-up display device which is capable of minimizing unnecessary operation of a light shielding device, is not complicated in structure and system, and is capable of sufficiently providing driving information to a driver.

The purposes to be achieved by the present disclosure are not limited to the above-mentioned purposes, and other purposes not mentioned will be clearly understood by those skilled in the art from the following description.

According to one embodiment of the present disclosure, the present disclosure provides a head-up display device comprising: a picture generation unit (PGU) configured to output an image; a first mirror disposed in front of the PGU along a frontward optical path and configured to change a path of the image, and configured to transmit at least a portion of a wavelength of light therethrough; a second mirror disposed in front of the first mirror along the frontward optical path, configured to pivot to between a first position and a second position, and configured to project the image while being at the first position and to block external incoming light while being at the second position; and a printed circuit board (PCB) on which at least one sensor is mounted, wherein the sensor measures an illuminance of the external incoming light incoming along a backward optical path opposite to the frontward optical path, wherein the at least one sensor is not positioned at a position of the PCB corresponding to a point of the first mirror which a chief ray generated from the PGU reaches, but is positioned at a position around the position of the PCB corresponding to the point of the first mirror which the chief ray reaches.

As described above, according to the present embodiment, there is an effect of providing the head-up display device capable of minimizing unnecessary operation of a light shielding device, not having complicated structure and system, and capable of sufficiently providing driving information to a driver.

### BRIEF DESCRIPTION OF THE DRAWINGS

FIG. 1 is a perspective view of a head-up display device according to an embodiment of the disclosure.

FIG. 2 is an exploded perspective view of a head-up display device according to an embodiment of the disclosure.

FIG. 3 is a diagram illustrating a path of a chief ray of a head-up display device according to an embodiment of the disclosure.

FIG. 4 is a rear perspective view of a first mirror cover and an PCB according to an embodiment of the disclosure.

FIG. 5 illustrates a concept in which solar light introduced into a head-up display device is concentrated into high thermal energy to apply thermal damage to an image output component.

FIGS. 6A and 6B each illustrates a head-up display device including a vehicle orientation angle sensor for determining whether to deactivate a protection mode according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components.

When a component is described as being “connected,” “coupled,” or “plugged” to another component, it is to be understood that the component may be directly connected or connected to the other component, but that another component may be “connected,” “coupled,” or “plugged” between each component.

Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

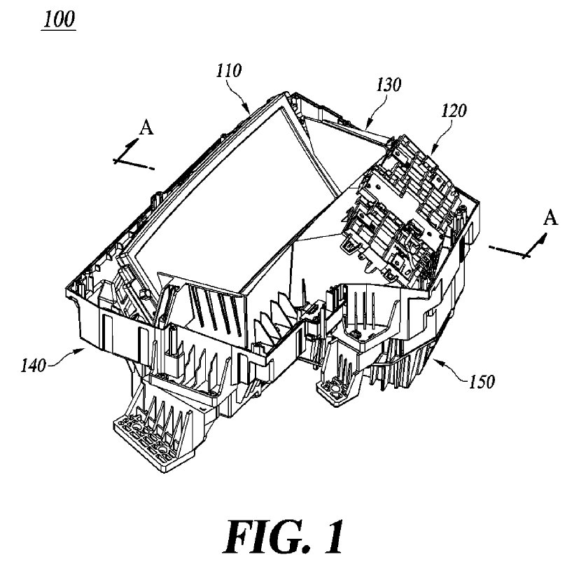

FIG. 1 is a perspective view of a head-up display device according to an embodiment of the disclosure;

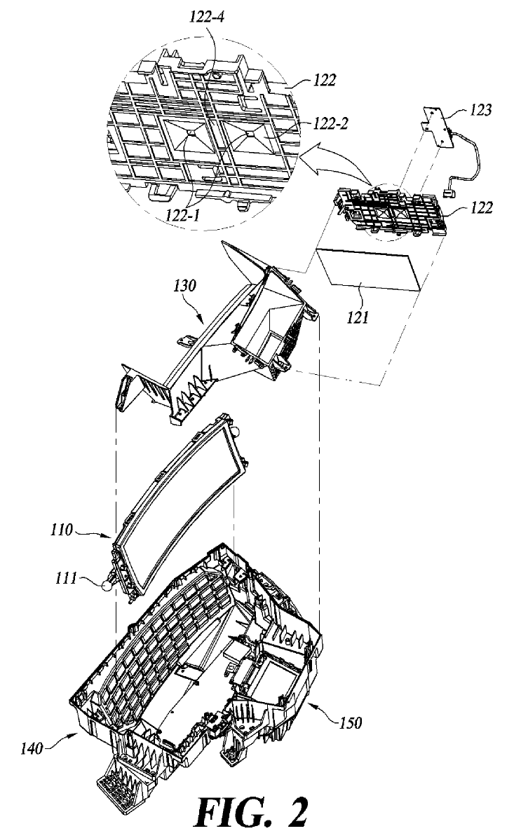

FIG. 2 is an exploded perspective view of a head-up display device according to an embodiment of the disclosure;

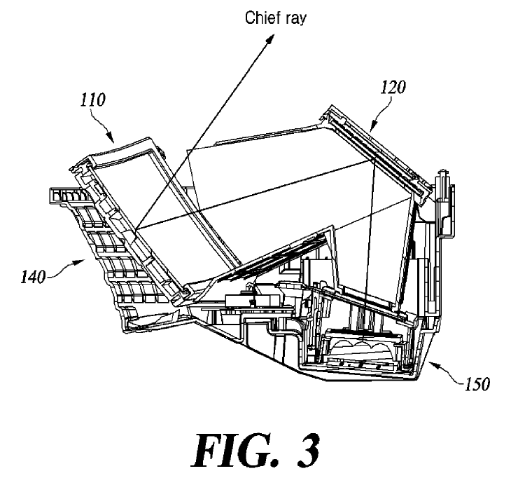

FIG. 3 is a diagram illustrating a path of a chief ray of a head-up display device according to an embodiment of the disclosure.

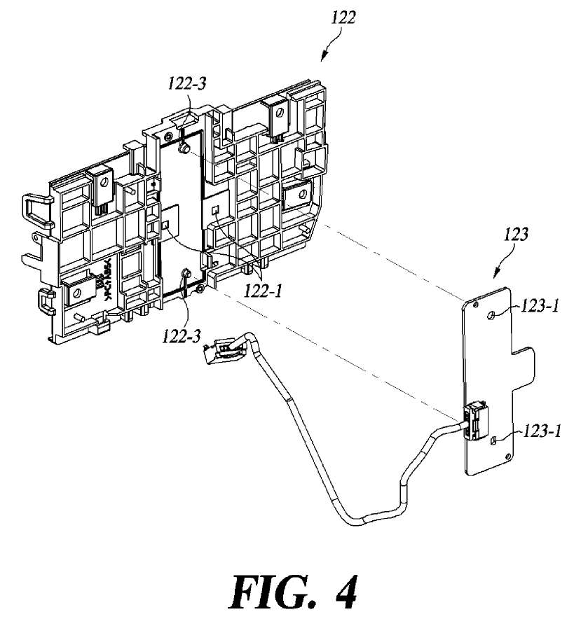

FIG. 4 is a rear perspective view of a first mirror cover and an PCB according to an embodiment of the disclosure.

Referring to FIGS. 1 to 4, a head-up display device 100 according to an embodiment of the disclosure may include all or some of a lower case 140, a picture generation unit (PGU) 150, a first mirror assembly 120, a second mirror 110, and a screen 130.

The lower case 140 includes an internal space for accommodating therein various components of the head-up display device 100. The lower case 140 may be configured to have a structure in which various components of the head-up display device 100 are coupled to each other therein. After various components of the head-up display device 100 are mounted into the lower case 140, an upper case (not shown) is coupled thereto, thereby completing the assembly of the head-up display device 100.

The PGU 150 outputs an image to be projected onto a windshield 2 of the vehicle. In the present specification, the PGU 150 may include various components for outputting an image. For example, the PGU 150 may include a liquid crystal display (LCD), an organic light-emitting diode (OLED), or a quantum dot light-emitting diode (QLED).

A first mirror 121 and the second mirror 110 are optical elements for magnifying and projecting the image output from the PGU 150 onto the windshield 2.

The first mirror assembly 120 may include the first mirror 121, a first mirror cover 122, and a printed circuit board (PCB) 123. The first mirror assembly 120 may be mounted on the screen 130 so as to be disposed fixedly inside the head-up display device 100.

The first mirror 121 may be disposed in front of the PGU 150 along a frontward optical path and may be configured to change a path of an image output from the PGU 150. The frontward optical path refers to a path through which the image output from the PGU 150 reaches the driver of the vehicle. The first mirror may be embodied as a folding mirror, a cold mirror, or the like to change a path of an image output from the PGU 150.

The first mirror 121 may be configured to transmit at least a portion of the wavelength of light therethrough. For example, the first mirror 121 may be configured to reflect light of a visible wavelength therefrom and transmit light of other wavelength regions therethrough.

Special coating may be performed on the first mirror 121 when manufacturing the first mirror 121 so that the first mirror 121 may transmit light in a partial wavelength band therethrough.

The first mirror cover 122 may be disposed on a rear surface of the first mirror 121 to fix the position of the first mirror 121. The first mirror cover 122 may be coupled to the screen 130 while the first mirror 121 is interposed therebetween to fix the first mirror 121.

The rear surface of the first mirror cover 122 may be formed to have a structure in which the PCB 123 may be mounted thereon. The first mirror cover 122 may include at least one protrusion 122-3 to mount the PCB 123 on the rear surface thereof. The at least one protrusion 122-3 may pass through a receiving hole 123-1 of the PCB 123. The receiving hole 123-1 of the PCB 123 may be embodied as an elongate hole or a positive hole. The positions of the first mirror cover 122 and the PCB 123 may be fixed using the protrusion 122-3 and the receiving hole 123-1 and then the first mirror cover 122 and the PCB 123 may be coupled to each other using a fastening means. The fastening means include a thread, a weld, a brazing, a rivet, or the like.

The PCB 123 may be mounted on the rear surface of the first mirror 121. At least one sensor 124 may be mounted on the front surface of the PCB 123. The at least one sensor 124 may measure an illuminance of external incoming light incoming along a backward optical path. The backward optical path is a path opposite to the frontward optical path, and is a path along which the external incoming light introduced from the outside out of the head-up display device 100 reaches the PGU 150. The external incoming light refers to all of light beams introduced from the outside out of the head-up display device 100 However, in the present disclosure, the external incoming light may particularly refer to sunlight.

The at least one sensor 124 may be a sensor for sensing light such as a photo sensor or a light sensor.

In the assembled head-up display device 100, the at least one sensor 124 may be disposed at a position around a position of the PCB corresponding to a point of the first mirror 121 which a chief ray generated from the PGU 150 reaches and may not be disposed at the position of the PCB corresponding to the point of the first mirror 121 which the chief ray generated from the PGU 150 reaches. For example, as shown in FIG. 2, the at least one sensor may be disposed at a position around a position of the PCB corresponding to a center portion 122-4 of the front surface of the first mirror cover 122. The central portion 122-4 is a portion which the chief ray PL reaches. The chief ray refers to a ray passing through the center of the screen of the head-up display device 100. The chief ray is a ray used as a reference when designing the optical system of the head-up display device 100, and plays an important role in determining the position and size of the screen of the head-up display device 100.

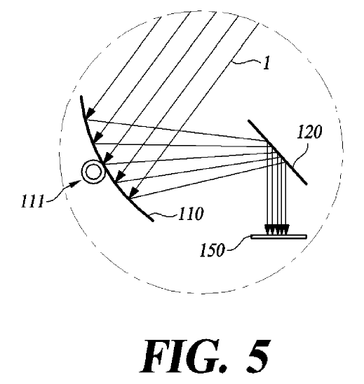

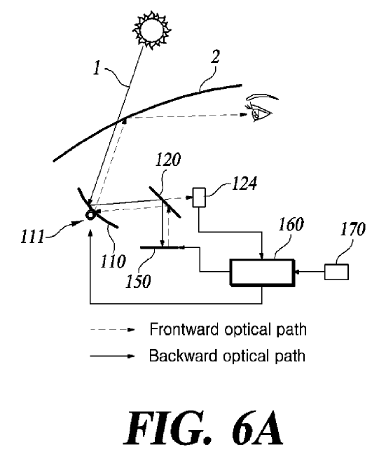

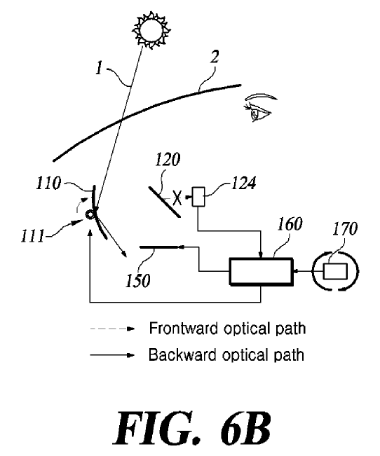

Since the at least one sensor 124 is positioned such that the chief ray does not reach the at least one sensor, the execution frequency of the protection mode for preventing deterioration of the PGU 150 may be optimized. A detailed description related to the protection mode and the positioning of the sensor 124 will be described later with reference to FIGS. 5, 6A and 6B.

In one example, the first mirror cover 122 may include at least one opening 122-1. The opening 122-1 is configured such that at least a portion of the external incoming light may pass through the opening defined in the first mirror cover 122 and directly reach the sensor 124. The opening 122-1 may be positioned at a position of the first mirror cover 122 corresponding to a position of each of the at least one sensor 124.

The opening 122-1 may be formed to have an inclination 122-2 such that a cross-sectional area size thereof is smaller as the opening extends in a direction from the front surface of the first mirror cover 122 toward the rear surface of the first mirror cover 122. Since the opening 122-1 has the inclination 122-2, the external incoming light introduced at various angles may easily reach the sensor 124.

The second mirror 110 may be disposed in front of the first mirror 121 along the frontward optical path and configured to change the path of the image output from the PGU 150 once again. In order for the second mirror 110 to change the path of the image output from the PGU 150 once again, the second mirror 110 may be embodied as a concave mirror, an aspherical mirror, or the like.

The second mirror 110 may be configured to pivot to between the first position and the second position. The second mirror 110 may pivot to between the first position and the second position around a pivot shaft 111. The second mirror 110 may project an image onto the windshield 2 while being at the first position and may block the external incoming light while being at the second position.

A schematic process in which the second mirror 110 pivots to between the first position and the second position to block the external incoming light is as follows.

The sensor 124 is disposed to measure the illuminance of the external incoming light. The sensor 124 transmits the illuminance information of the external incoming light to a controller 160.

Based on the illuminance information of the incoming light, the controller 160 operates a motor (not shown) to pivot the second mirror 110 using the motor.

In the head-up display device 100 according to the present disclosure, using the second mirror 110 as the light blocking device may allow a separate additional component for blocking the external incoming light to be omitted. In particular, in the case of a large-screen head-up display device, it is preferable that the volume thereof is minimized in order that the large-screen head-up display device may be installed in a limited space in a vehicle. Rather than employing a movable separate large component, it is preferable that the component of the optical system is formed to block the external incoming light. The second mirror 110 configured in a pivotable form using power generated from a power device may perform the light blocking function while minimizing an increase in volume of the head-up display device 100.

The screen 130 is coupled to the lower case 140 so as to prevent the light inside the head-up display device 100 from being randomly reflected and emitted.

FIG. 5 illustrates a concept in which solar light introduced into a head-up display device is concentrated into high thermal energy such that the thermal damage is applied to an image output component.

FIGS. 6A and 6B are schematic diagrams of a head-up display device including a vehicle orientation angle sensor for determining whether to deactivate a protection mode according to an embodiment of the present disclosure. Specifically, FIG. 6A illustrates a case in which the protection mode of the head-up display device 100 is deactivated and the second mirror 110 is at the first position. FIG. 6B illustrates a case where the protection mode of the head-up display device 100 is activated and the second mirror 110 is at the second position.

Referring to FIGS. 5, 6A and 6B, the head-up display device 100 according to an embodiment of the disclosure may further include the controller 160 and a vehicle orientation angle sensor 170 to activate or deactivate the protection mode for preventing thermal damage to an image output component.

The controller 160 compares the illuminance of the external incoming light measured by the sensor 124 with a threshold value and controls activation and deactivation of the protection mode based on the comparing result. The threshold value is defined as the illuminance at which light incident on the PGU 150 can cause irreversible damage to the PGU 150. That is, the threshold value is defined as the illuminance at which light incident on the PGU 150 may cause thermal damage to an image output component included in the PGU 150. The protection mode is a mode in which the second mirror 110 is pivoted to the second position so that the external incoming light is not incident on the PGU 150. For example, in a state in which the protection mode is activated, the second mirror 110 pivots to the second position so that the sunlight 1 introduced from the outside is not transmitted to the PGU 150, thereby changing the optical path.

In one example, when the controller 160 receives a signal about the illuminance of the external incoming light from the at least one sensor 124 and receives a signal equal to or greater than a preset threshold value from all of the at least one sensor 124, the controller may determine that the illuminance of the external incoming light is equal to or greater than the threshold value, and thus may cause thermal damage to the PGU 150.

However, when the at least one sensor 124 is disposed at a position coinciding with a position of a point of the first mirror which the chief ray reaches, the controller 160 may unnecessarily activate the protection mode a large number of times. The case where the activation of the protection mode is unnecessary is a case where it is determined that the external incoming light is not incident on the PGU 150, but the external incoming light is incident on the at least one sensor 124, thereby causing the thermal damage to the PGU 150. When the protection mode is unnecessarily activated a lot, the frequency at which an image is not output to the driver increases, which may cause inconvenience to the driver's driving.

In order to minimize the unnecessary protection mode activation by the controller 160, the head-up display device 100 according to the present disclosure has the at least one sensor 124 positioned at a position around a position of the PCB corresponding to a position of a point of the first mirror which the chief ray reaches. In addition, only when all of the at least one sensor 124 outputs a signal equal to or greater than the threshold value, the controller 160 is configured to determine that the illuminance of the external incoming light is equal to or greater than the threshold value at which the thermal damage to the PGU occur. In this regard, a position of the PCB around the position of the PCB corresponding to the point of the first mirror which the chief ray reaches excludes the position of the PBC corresponding to the point of the first mirror which the chief ray reaches. It is preferable that the at least one sensor 124 is disposed at a position at each of the left side and the right side around the position of the PCB corresponding to the point of the first mirror which the chief ray reaches. The specific position of the at least one sensor 124 may be optimized through an experiment.

In the head-up display device 100 in which the protection mode is activated in an embodiment, the light transmission path of the external incoming light is different from the light transmission path along which the image of the PGU 150 is projected, and the sensor 124 does not measure the external incoming light. Therefore, in order to determine whether the protection mode is deactivated in response to a change in the incident angle of the external incoming light, a separate means such as the vehicle orientation angle sensor 170 according to an embodiment is required.

The vehicle orientation angle sensor 170 measures and provides vehicle orientation angles including roll, yaw, and pitch of the vehicle. The vehicle orientation angle may be measured using an inertia measurement unit (IMU) type vehicle orientation angle sensor 170 such as a gyro sensor.

The vehicle orientation angle sensor 170 continuously measures the vehicle orientation angle including the roll, yaw, and pitch angles, and the controller may use the change in the vehicle orientation angle to determine whether to execute the activation of the protection mode and the deactivation of the protection mode.

In one example, the steering wheel steering angle information may be additionally utilized to improve measurement accuracy and speed of the vehicle orientation angle. The steering wheel steering angle information may be used to more quickly determine the moving direction of the vehicle before the change in the orientation angle of the vehicle is measured by the vehicle orientation angle sensor 170. In order to more accurately measure the vehicle orientation angle, a vehicle speed may be used together with the steering wheel steering angle information.

In an embodiment, the deactivation of the protection mode is determined based on a change in the vehicle orientation angle. When the vehicle orientation angle is changed under the driving and moving of the vehicle in the protection mode activated state, that is, when it is determined that the incident angle of the sunlight 1 is out of the range of the thermal damage causing angle at which the damage to the PGU 150 occurs, that is, the sunlight is not incident on the PGU 150, the controller 160 deactivates the protection mode.

The controller 160 is configured to periodically and always receive the measurement of the vehicle orientation angle. The controller 160 determines the vehicle orientation angle at the time when the protection mode is activated as the sunlight incoming angle, and records the roll, yaw, and pitch angles corresponding thereto.

In the state in which the protection mode is activated, the controller 160 continuously receives the detecting result of the vehicle orientation angle according to the movement of the vehicle, and adds the change amount to the vehicle orientation angle at the time when the protection mode is set, thereby calculating the sunlight incoming angle.

The controller 160 deactivates the protection mode when it is determined that the sunlight incoming angle is out of the damage causing angle range. On the other hand, when it is determined that the sunlight incoming angle is within the damage causing angle range, the controller maintains the activation of the protection mode.

Since the protection mode deactivation method according to an embodiment is executed based on the measuring result from the vehicle orientation angle sensor 170 that can always measure the vehicle orientation angle regardless of whether the protection mode is activated, the method can accurately determine the deactivation time point of the protection mode.

The damage causing angle range may be pre-identified and preset according to the optical system structure of the head-up display device 100 mounted on the vehicle. In one example, the vehicle orientation angle and the damage causing angle range include information on roll, yaw, and pitch angles. That is, in an embodiment, the solar light incoming angle and the damage causing angle range are variables expressed as vectors.

It may be difficult to determine an additional situation in which the protection mode can be deactivated only based on the information obtained from the vehicle orientation angle sensor 170. For example, a situation such as the vehicle entering a tunnel/underpass, driving in an alpine area, driving in a high-rise building-dense area or changing weather (cloudy/rainy), and driving in a night driving state may occur. In this case, the controller 160 may determine whether to deactivate the protection mode additionally using the vehicle information.

The vehicle information includes location information recognized with a GPS (or GLONASS, Galileo system) and navigation map data in the vehicle. The vehicle information may be supplemented by including relative movement information of the vehicle obtained from the vehicle orientation angle sensor 170 in consideration of a case in which GPS reception is not smooth. In addition, the GPS information may be used to determine whether to deactivate the protection mode based on the position of the sun as calculated using the date, time, position, azimuth, and the like at the measurement time. Since the position of the sun gradually changes at a constant speed, precision may be easily secured via repeated calculations thereof even when the reception state of the GPS is not intermittently smooth.

The vehicle information includes information such as structures and topography around the vehicle that may affect the sunlight incoming amount. For example, information such as a high-rise building, a mountain, a tunnel, etc. around a road on which the vehicle travels may be included therein.

In addition, the vehicle information may further include information that may affect an incoming amount of the incident sunlight, such as weather information recognized from a terminal mounted on the vehicle. The information may include data from an illuminance sensor (not shown) for detecting brightness around the vehicle, whether a taillight is automatically turned on, or whether a rain sensor (not shown) detects rainfall. Such information may be transmitted to the controller 160 via the controller area network (CAN) or Ethernet communication in the vehicle. In this regard, the automatic lighting of the taillight means a case in which the front and backward lights are automatically turned on because the surroundings of the vehicle become dark.

The controller 160 may deactivate the protection mode when it is determined that the incoming illuminance of the sunlight 1 is weakened to a level below a threshold value due to weather and the surrounding environment around the vehicle.

The illuminance sensor measures brightness around the vehicle under the control of the controller 160. The illuminance sensor may measure the brightness around the vehicle using an CdS cell as a semiconductor optical sensor using a photo conductive effect. The illuminance sensor may be installed around the front windshield of the vehicle to measure the brightness of a position in front of the vehicle that the driver is looking at. The number thereof may be one or more as necessary. However, the present embodiment is not limited thereto, and various sensors capable of measuring the brightness around the vehicle may be employed.

When it is determined based on the vehicle information that the vehicle is expected to enter the tunnel/underpass while the protection mode is activated, the controller 160 may deactivate the protection mode before entering the tunnel even when it is determined that the sunlight 1 is being introduced to the vehicle. That is, the protection mode may be deactivated before a predetermined safe time duration set such that irreversible thermal damage does not occur to the PGU 150, with reference to the vehicle speed during driving and the time required to enter the tunnel. This consideration has the effect of minimizing a time duration for which the driving information of the head-up display device 100 is prevented from being displayed while preventing the thermal damage to the PGU 150.

The exit of the vehicle from the tunnel/underpass may be determined using the vehicle information and the driving distance of the vehicle. In addition, the driving direction and the expected orientation angle of the vehicle at the tunnel/underpass exit position may be identified based on the vehicle information. Based on this information, the controller 160 may determine the possibility at which the external sunlight 1 is incident into the head-up display device 100 and then determine whether to activate the protection mode or maintain the deactivated state of the protection mode after a predetermined time elapse after exiting the tunnel/underpass.

It may be important to provide safety-related information to the driver via the head-up display device 100 before the vehicle enters the tunnel and after the vehicle exits the tunnel. Before the vehicle enters the tunnel and after the vehicle exits the tunnel, the driver's situational awareness may be deteriorated due to a sudden change in ambient brightness, and there is a high risk of a collision. Therefore, it is preferable that the head-up display device 100 operates to provide the safety-related information to the driver before the vehicle enters the tunnel and after the vehicle exits the tunnel.

The head-up display device 100 determines whether to deactivate the protection mode additionally using the vehicle information, and maintains the information providing state of the head-up display device 100 before the vehicle enters the tunnel/underpass and after the vehicle exits the tunnel/underpass, thereby providing a safer driving environment.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

What is claimed is:

1. A head-up display device comprising:
a picture generation unit (PGU) configured to output an image;
a first mirror disposed in front of the PGU along a frontward optical path and configured to change a path of the image, and configured to transmit at least a portion of a wavelength of light therethrough;
a second mirror disposed in front of the first mirror along the frontward optical path, configured to pivot to between a first position and a second position, and configured to project the image while being at the first position and to block external incoming light while being at the second position; and
a printed circuit board (PCB) on which at least one sensor is mounted, wherein the sensor measures an illuminance of the external incoming light incoming along a backward optical path opposite to the frontward optical path,
wherein the at least one sensor is not positioned at a position of the PCB corresponding to a point of the first mirror which a chief ray generated from the PGU reaches, but is positioned at a position around the position of the PCB corresponding to the point of the first mirror which the chief ray reaches.

2. The head-up display device of claim 1, wherein the head-up display device further comprises a controller, wherein upon determination that the illuminance of the external incoming light is greater than or equal to a threshold value at which the external incoming light can cause thermal damage to the PGU, the controller is configured to allow the second mirror to pivot to the second position to activate a protection mode.

3. The head-up display device of claim 2, wherein the controller is further configured to:
receive a signal about the illuminance of the external incoming light from the at least one sensor; and
upon receiving a signal equal to or greater than a predetermined threshold value from all of the at least one sensor, determine that the illuminance of the external incoming light is equal to or greater than the threshold value at which the external incoming light can cause the thermal damage to the PGU.

4. The head-up display device of claim 2, wherein upon determination that the illuminance of the external incoming light is lower than the threshold value at which the external incoming light can cause the thermal damage to the PGU, the controller is further configured to allow the second mirror to pivot to the first position to deactivate the protection mode.

5. The head-up display device of claim 2, wherein the controller is further configured to collect vehicle information using a controller area network (CAN) or Ethernet communication in a vehicle, and to determine whether to deactivate the protection mode based on the vehicle information.

6. The head-up display device of claim 1, wherein the head-up display device further comprises a first mirror cover disposed on a rear surface of the first mirror and configured to fix a position of the first mirror, wherein the first mirror cover has a structure in which the PCB is mounted on a rear surface thereof.

7. The head-up display device of claim 6, wherein the first mirror cover includes at least one opening defined therein to allow at least a portion of the external incoming light to pass through the opening of the first mirror cover and then reach the at least one sensor,
wherein the opening is positioned at a position corresponding to a position of each of the at least one sensor.

8. The head-up display device of claim 7, wherein the at least one opening has an inclination such that a cross-sectional area size thereof decreases as the opening extends in a direction from a front surface of the first mirror cover toward a rear surface of the first mirror cover.

9. The head-up display device of claim 6, wherein the first mirror cover includes at least one protrusion formed on a rear surface thereof for fixing the PCB to the first mirror cover,
wherein the PCB includes a receiving hole defined therein for receiving therein the at least one protrusion.

10. The head-up display device of claim 1, wherein the at least one sensor includes two sensors.
